(19) United States
(12) Patent Application Publication
(10) Pub. No.: US 2025/0173240 A1
(43) Pub. Date: May 29, 2025

(54) DETECTING AN UNTRUSTWORTHY PERIOD OF A METRIC

(71) Applicant: Microsoft Technology Licensing, LLC, Redmond, WA (US)

(72) Inventors: Yiqin YU, Redmond, WA (US); Jianrong WEN, Beijing (CN); Han LI, Redmond, WA (US); Yang TAI, Redmond, WA (US)

(21) Appl. No.: 18/841,967

(22) PCT Filed: Jan. 28, 2023
(86) PCT No.: PCT/US2023/011794

§ 371 Date: Aug. 27, 2024

(30) Foreign Application Priority Data
Apr. 13, 2022 (CN) 202210387169.1

(51) Int. Cl. G06F 11/34; G06F 11/30

(52) U.S. Cl. CPC G06F 11/3466; G06F 11/3072; G06F 11/3419

(57) ABSTRACT

The present disclosure proposes a method, apparatus and computer program product for detecting an untrustworthy period of a metric. Time-series data for a target metric may be obtained, the time-series data including a plurality of data windows. A start data window and an end data window of an untrustworthy period of the target metric may be identified from the time-series data, the untrustworthy period indicating a time interval in which data values of the target metric are untrustworthy. The untrustworthy period may be detected based on the start data window and the end data window.

### BACKGROUND

Many companies usually monitor time-series data for some metrics, to supervise the health of their products, services, businesses, etc. Herein, a metric may refer to a parameter used to measure the degree of development of an object. Metrics may include, e.g., click-through rate, usage rate, search success rate, etc. Some key metrics may also be referred to as Key Performance Indicator (KPI). Time-series data may refer to a data sequence recorded in chronological order, and data points in the data sequence reflect the status or degree of change in a particular metric over time. Time-series data for a metric may be continuously monitored through an anomaly detection system, and an alert may be issued when an abnormal event is detected.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose a method, apparatus and computer program product for detecting an untrustworthy period of a metric. Time-series data for a target metric may be obtained, the time-series data including a plurality of data windows. A start data window and an end data window of an untrustworthy period of the target metric may be identified from the time-series data, the untrustworthy period indicating a time interval in which data values of the target metric are untrustworthy. The untrustworthy period may be detected based on the start data window and the end data window.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for detecting an untrustworthy period of a metric according to an embodiment of the present disclosure.

FIG. 2 illustrates a schematic diagram of time-series data for a target metric according to an embodiment of the present disclosure.

FIG. 3 illustrates an exemplary process for identifying a start data window and an end data window of an untrustworthy period of a target metric according to an embodiment of the present disclosure.

FIG. 4 illustrates an exemplary process for estimating a movement pattern of a data window according to an embodiment of the present disclosure.

FIG. 5 illustrates an exemplary process for determining a compensation status of a current data window according to an embodiment of the present disclosure.

FIG. 6 illustrates a schematic diagram of time-series data where there is no intermediate data window between a current data window and a start data window according to an embodiment of the present disclosure.

FIG. 7 illustrates a schematic diagram of time-series data where there is one intermediate data window between a current data window and a start data window according to an embodiment of the present disclosure.

FIG. 8 is a flowchart of an exemplary method for detecting an untrustworthy period of a metric according to an embodiment of the present disclosure.

FIG. 9 illustrates an exemplary apparatus for detecting an untrustworthy period of a metric according to an embodiment of the present disclosure.

FIG. 10 illustrates an exemplary apparatus for detecting an untrustworthy period of a metric according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure. Existing anomaly detection systems usually can detect abnormal data points in time-series data for a target metric. Herein, a target metric may refer to a metric whose time-series data is monitored. A current data point may be detected as an abnormal data point if the data value of the current data point fluctuates or varies greatly compared to data values of one or several previous data points. That is to say, an abnormal data point detected by an existing abnormality detection system reflects a fluctuating or changing data point in time-series data. If time-series data fluctuates greatly at a certain time, but remains stable for a time period later, data points during that period will not be detected as abnormal data points. However, the data points during this period are actually anomalous due to fluctuation in the previous period. The existing anomaly detection systems cannot know during which period time-series data for a target metric is abnormal. Time-series data in an abnormal status is untrustworthy.

Embodiments of the present disclosure propose detecting an untrustworthy period of a metric. An untrustworthy period of a target metric may be automatically detected. An untrustworthy period of a target metric may refer to a time interval in which data values of the target metric are untrustworthy. Knowing the untrustworthy period of the target metric is important in a data-driven decision-making environment. Data-driven decisions related to the target metric may be made outside the untrustworthy period of the target metric, so that the decision-making is not affected by fluctuations in the target metric data values itself. Data-driven decisions may be, e.g., scaling up a product, releasing a new feature, etc. The untrustworthy period may correspond to a time-series data segment in time-series data, and the range of the time-series data segment may be defined by a start data window and an end data window. Herein, a data window may refer to a time-series data unit having a predetermined time interval in time-series data. A start data window may correspond to a data window in which data values of a target metric starts to appear abnormal. An end data window may correspond to a data window in which data values of a target metric starts to return to normal.

In an aspect, the embodiments of the present disclosure propose to perform online detection on time-series data for a target metric, to identify, from the time-series data, a start data window and an end data window of an untrustworthy period of the target metric. For example, when a current data window arrives, it may be identified to determine whether the current data window is a start data window or an end data window of an untrustworthy period. When it is determined, through performing anomaly detection on the current data window, that the current data window contains an abnormal data value, it may be determined whether there is an unfinished untrustworthy period. If it is determined that there is no unfinished untrustworthy period, the current data window may be identified as a start data window, and a new untrustworthy period may be created. If it is determined that there is an unfinished untrustworthy period, further analysis may be performed on the current data window. For example, it may be determined whether a compensation status of the current data window meets a predetermined requirement. The compensation status of the current data window may be used to evaluate whether the data value change of the current data window does compensate for the data value change of a previous data window. If the compensation status of the current data window meets the predetermined requirement, the current data window may be identified as an end data window, and the unfinished untrustworthy period may finish. If the compensation status of the current data window does not meet the predetermined requirement, the current data window may be identified as an intermediate data window, and the unfinished untrustworthy period will continue until an end time window is identified. Herein, an intermediate data window may refer to a data window that is between a start data window and an end data window and contains an abnormal data value. Through the above approach, a start data window and an end data window of an untrustworthy period of a target metric may be identified from time-series data in real time and accurately, thereby timely and reliably detecting an untrustworthy period of the target metric for use by decision makers.

In another aspect, the embodiments of the present disclosure propose to determine whether a compensation status of a current data window meets a predetermined requirement based at least on a movement pattern of the current data window and a movement pattern of a start data window of an unfinished untrustworthy period. A movement pattern of a data window may include, e.g., a movement direction, a movement level and a movement speed, etc., of the data window. A movement direction of a data window may indicate whether data values in the data window are increasing or decreasing. A movement level of a data window may indicate a degree of change in data values in the data window. A movement speed of a data window may indicate a speed of change in data values in the data window. Firstly, it may be determined whether a current movement direction of the current data window is consistent with a movement direction of the start data window of the unfinished untrustworthy period. If being consistent, it indicates that the data values of both the current data window and the start data window are increased or decreased. At this time, the data value change of the current data window cannot compensate for the data value change of the start data window. Therefore, the compensation status of the current data window does not meet the predetermined requirement. If being inconsistent, it may be further determined whether there is at least one intermediate data window between the current data window and the start data window. If there is no intermediate data window, it may be determined whether a compensation status of the current data window meets a predetermined requirement based on a movement pattern of the current data window and a movement pattern of the start data window. If there is an intermediate data window, it may be determined whether a compensation status of the current data window meets the predetermined requirement based on a movement pattern of the current data window, at least one movement pattern of the at least one intermediate data window, and a movement pattern of the start data window. Through the above approach, the current data window may be comprehensively evaluated, to accurately determine whether the data value change of the current data window indeed compensates for the data value change of a previous data window, thereby the end time window in which time-series data for the target metric returns to normal values may be reliably identified.

In yet another aspect, identification of a start data window and an end data window according to the embodiments of the present disclosure is performed on data of time-series data. The data of time-series data is easy to obtain and process. For example, for a start data window, a start data window may be identified based on whether a current data window contains an abnormal data value and whether there is an unfinished untrustworthy period. For an end data window, an end data window may be identified through determining a compensation status of a current data window by a movement pattern such as a movement direction, a movement level, a movement speed, etc. Whether a current data window contains an abnormal data value may be determined through existing anomaly detection techniques. The movement direction, the movement level, the movement speed of each time window may be calculated from a start time, an end time, a start data value, an end data value, etc. of the time window. Identification of a start data window and an end data window according to the embodiments of the present disclosure focuses on processing the data of the time-series data, and avoids the need to analyze a root cause of an abnormal data value. The analysis on the root cause is a complex and challenging task, especially for an aggregated metric or a derived metric that is aggregated layer by layer.

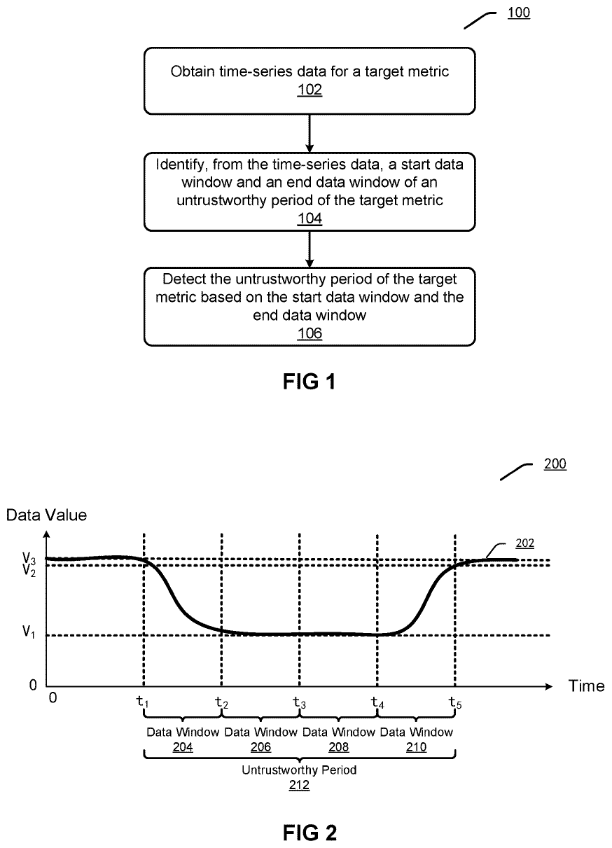

FIG. 1 illustrates an exemplary process 100 for detecting an untrustworthy period of a metric according to an embodiment of the present disclosure. Knowing the untrustworthy period of a target metric is important in a data-driven decision-making environment. Data-driven decisions related to the target metric may be made outside the untrustworthy period of the target metric, so that the decision-making is not affected by fluctuations in the target metric data values itself.

At 102, time-series data for a target metric may be obtained. The time-series data may be recorded continuously over time. The time-series data may include a series of data points collected at a plurality of time points. The time-series data may include a plurality of data windows. Each data window may be formed by data points over a certain period of time. FIG. 2 illustrates a schematic diagram 200 of time-series data for a target metric according to an embodiment of the present disclosure. In the schematic diagram 200, time-series data 202 may be a curve consisting of a set of data points for a target metric. The horizontal axis may represent time of respective data points, and the vertical axis may represent data values of respective data points. The time-series data 202 may include a plurality of data windows, e.g., a data window 204, a data window 206, a data window 208, a data window 210, etc. Each data window may have the same time interval. The data windows 204 may be a time-series data segment spanned from time t₁ to time t₂; the data windows 206 may be a time-series data segment spanned from time t₂ to time t₃; etc.

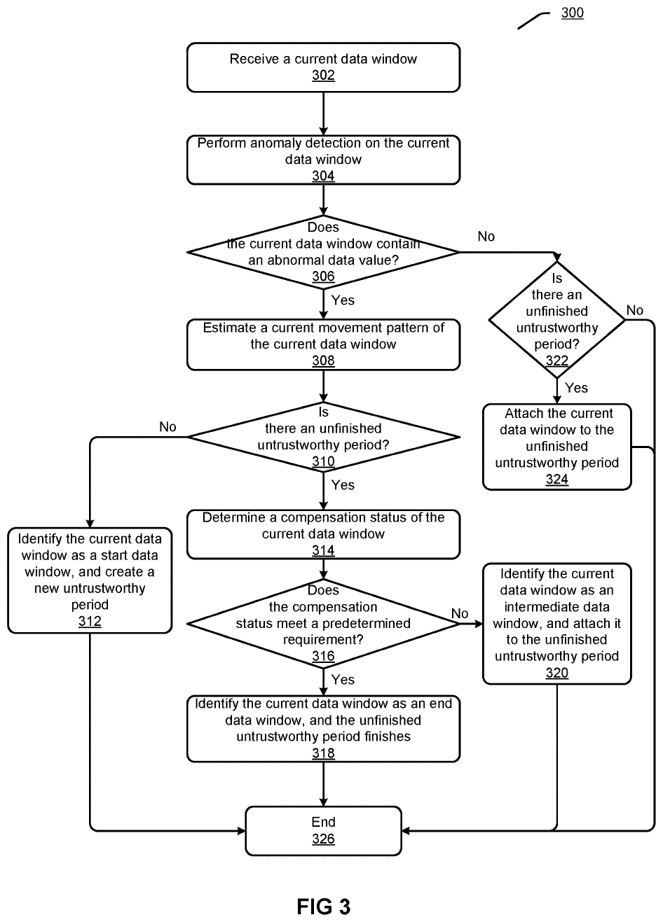

At 104, a start data window and an end data window of an untrustworthy period of the target metric may be identified from the time-series data. The untrustworthy period may indicate a time interval in which data values of the target metric are untrustworthy. Online detection may be performed on the time-series data, to identify, from the time-series data, a start data window and an end data window of an untrustworthy period of the target metric in real time. For example, when a current data window arrives, it may be identified to determine whether the current data window is a start data window or an end data window of an untrustworthy period. An exemplary process for identifying a start data window and an end data window will be described later in conjunction with FIG. 3. Taking the time-series data 202 in FIG. 2 as an example, the data window 204 may be identified as a start data window, and the data window 210 may be identified as an end data window.

At 106, the untrustworthy period of the target metric may be detected based on the identified start data window and end data window. For example, a time-series data segment in the time-series data including the start data window and the end data window may be determined. Subsequently, the determined time-series data segment may be detected as the untrustworthy period. The untrustworthy period may be represented as, e.g., UP={xₜ_{ₛₜₐᵣₜ}, . . . , xₜ_{_{end}}|0≤tₛₜₐᵣₜ≤t_{end}}, where xₜ_{ₛₜₐᵣₜ} may represent the start data window, and xₜ_{_{end}} may represent the end data window. Continuing to take the time-series data 202 in FIG. 2 as an example, a time-series data segment in the time-series data 202 including the start data window and the end data window may be a time-series data segment composed of the data window 204, the data window 206, the data window 208 and the data window 210. The time-series data segment may be detected as an untrustworthy period 212.

It should be appreciated that the process for detecting the untrustworthy period of the metric described above in conjunction with FIGS. 1 and 2 is merely exemplary. According to actual application requirements, the steps in the process for detecting the untrustworthy period of the metric may be replaced or modified in any manner, and the process may include more or fewer steps.

FIG. 3 illustrates an exemplary process 300 for identifying a start data window and an end data window of an untrustworthy period of a target metric according to an embodiment of the present disclosure. The process 300 may correspond to the step 104 in FIG. 1. Time-series data may be recorded continuously over time. When a current data window arrives, it may be identified to determine whether the current data window is a start data window or an end data window of an untrustworthy period.

At 302, a current data window may be received.

Subsequently, it may be determined whether the current data window contains an abnormal data value. It may be determined whether the current data window contains an abnormal data value through performing anomaly detection. At 304, anomaly detection may be performed on the current data window. The anomaly detection may be performed on the current data window through known anomaly detection techniques. In an implementation, anomaly detection algorithm based on frequency domain spectral residual and a convolutional neural network may be employed to perform anomaly detection on the current data window. For example, data values of the current data window may be firstly transformed from the time domain to the frequency domain through Fourier transform. Subsequently, an abnormal data value may be detected from a frequency domain curve through a trained deep learning model.

At 306, it may be determined whether the current data window contains an abnormal data value. If it is determined at 306 that the current data window contains an abnormal data value, further analysis of the current data window may be performed, to identify the current data window as a start data window, an end data window, an intermediate data window, etc.

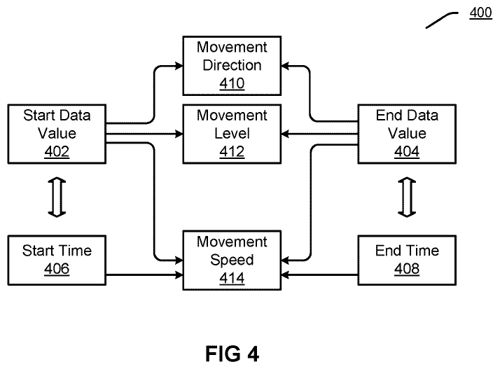

The process 300 may proceed to 308, where a current movement pattern of the current data window is estimated. Herein, a movement pattern of a current data window may be referred to as a current movement pattern. The current data window may have a start time, an end time, a start data value, and an end data value. A start data value may be a data value corresponding to a start time. An end data value may be a data value corresponding to an end time. Taking the time-series data 202 in FIG. 2 as an example, it is assumed that the data window 210 is a current data window. The start time of the data window 210 may be t₄, the end time may be t₅, the start data value may be v₁, and the end data value may be v₂. A current movement pattern of the current data window may include, e.g., a current movement direction, a current movement level, a current movement speed, etc., of the current data window. FIG. 4 illustrates an exemplary process 400 for estimating a movement pattern of a data window according to an embodiment of the present disclosure. The data window may be, e.g., a current data window.

A movement direction 410 of the data window may be determined based on a start data value 402 and an end data value 404 of the data window. The start data value 402 may be denoted as vₛₜₐᵣₜ. The end data value 404 may be denoted as v_{end}. A process for determining the movement direction 410 of the data window may be represent by, e.g., the following equation:

$${Derection}_{current} = sgn ( {v}_{end} - {v}_{start} ) \qquad ( 1 )$$

When the sign of Derection_{current} is positive, it indicates that data values of the data window are increasing. When the sign of Derection_{current} is negative, it indicates that data values of the data window are decreasing.

A movement level 412 of the data window may be calculated based on the start data value 402 and the end data value 404 of the data window. A process for calculating the movement level 412 of the data window may be represent by, e.g., the following equation:

$${Level}_{current} = \vert \frac{{v}_{end} - {v}_{start}}{{v}_{start}} \vert \qquad ( 2 )$$

A movement speed 414 of the data window may be calculated based on the start data value 402, the end data value 404, the start time 406, and the end time 408 of the data window. The start time 406 may be denoted as tₛₜₐᵣₜ. The end time 408 may be denoted as t_{end}. A process for calculating the movement speed 414 of the data window may be represent by, e.g., the following equation:

$${Speed}_{current} = \vert \frac{{v}_{end} - {v}_{start}}{{t}_{end} - {t}_{start}} \vert \qquad ( 3 )$$

The current movement pattern of the current data window may be estimated through the process 400, e.g., the current movement direction, the current movement level, the current movement speed, etc. The current movement pattern may be used to determine a compensation status of the current data window, or may be recorded for determining a compensation status of a subsequent data window.

Referring back to FIG. 3, after estimating the current movement pattern of the current data window, the process 300 may proceed to 310, where it is determined whether there is an unfinished untrustworthy period.

If it is determined at 310 that there is no unfinished untrustworthy period, the process 300 may proceed to 312, where the current data window is identified as a start data window, and a new untrustworthy period may be created. Subsequently, operations for the current data window may end at 326.

If it is determined at 310 that there is an unfinished untrustworthy period, the process 300 may proceed to 314, where a compensation status of the current data window is determined. The compensation status of the current data window may be used to evaluate whether the data value change of the current data window does compensate for the data value change of a previous data window. If the compensation status of the current data window meets the predetermined requirement, the current data window may be identified as an end data window, and the unfinished untrustworthy period may finish. If the compensation status of the current data window does not meet the predetermined requirement, the current data window may be identified as an intermediate data window, and the unfinished untrustworthy period will continue until an end time window is identified. An exemplary process for determining a compensation status of a current data window will be described later in conjunction with FIG. 5.

At 316, it may be determined whether the compensation status of the current data window meets a predetermined requirement. In an implementation, the compensation status of the current data window may be represented by Boolean values “true” and “false”. When it is determined that the compensation status meets the predetermined requirement, the compensation status may be set to “true”; and when it is determined that the compensation status does not meet the predetermined requirement, the compensation status may be set to “false”.

If it is determined at 316 that the compensation status of the current data window meets the predetermined requirement, the process 300 may proceed to 318, where the current data window is identified as an end data window, and the unfinished untrustworthy period finishes. Subsequently, operations for the current data window may end at 326.

If it is determined at 316 that the compensation status of the current data window does not meet the predetermined requirement, the process 300 may proceed to 320, where the current data window is identified as an intermediate data window, and the current data window may be attached to the unfinished untrustworthy period. Subsequently, operations for the current data window may end at 326.

Return to the step 306, if it is determined at 306 that the current data window does not contain an abnormal data value, the process 300 may proceed to 322, where it is determined whether there is an unfinished untrustworthy period.

If it is determined at 322 that there is no unfinished untrustworthy period, operations for the current data window may end at 326.

If it is determined at 322 that there is an unfinished untrustworthy period, the process 300 may proceed to 324, where the current data window is attached to the unfinished untrustworthy period. Subsequently, operations for the current data window may end at 326.

The process 300 may be performed sequentially for each data window in the time-series data for the target metric, so that the start data window and the end data window of the untrustworthy period of the target metric may be identified from the time-series data. The identified start data window and end data window may be used to define the untrustworthy period of the target metric.

In the process 300, online detection may be performed on the time-series data for the target metric, to identify, from the time-series data, the start data window and the end data window of the untrustworthy period of the target metric. For example, when a current data window arrives, it may be identified to determine whether the current data window is the start data window or the end data window of the untrustworthy period. Through the process 300, the start data window and the end data window of the untrustworthy period of the target metric may be identified from the time-series data in real time and accurately, thereby timely and reliably detecting the untrustworthy period of the target metric for use by decision makers.

It should be appreciated that the process for identifying the start data window and the end data window of the untrustworthy period of the target metric described above in conjunction with FIG. 3 is merely exemplary. According to actual application requirements, the steps in the process for identifying the start data window and the end data window may be replaced or modified in any manner, and the process may include more or fewer steps. In addition, the specific order or hierarchy of the steps in the process 300 is only exemplary, and the process for identifying the start data window and the end data window may be performed in an order different from the described one.

FIG. 5 illustrates an exemplary process 500 for determining a compensation status of a current data window according to an embodiment of the present disclosure. The process 500 may correspond to the step 314 in FIG. 3. In the case where it is determined that there is an unfinished untrustworthy period, i.e., a start data window has been identified from the time-series data, but an end data window corresponding to the start data window has not been identified from the time-series data, the process 500 is performed. In the process 500, a compensation status of a current data window may be determined based at least on a current movement pattern of the current data window and a start movement pattern of a start data window of a unfinished untrustworthy period. The compensation status of the current data window may be represented by, e.g., Boolean values “true” and “false”. When it is determined that the compensation status meets the predetermined requirement, the compensation status may be set to “true”; and when it is determined that the compensation status does not meet the predetermined requirement, the compensation status may be set to “false”.

At 502, a start movement pattern of a start data window of an unfinished untrustworthy period may be obtained. Herein, a movement pattern of a start data window may be referred to as a start movement pattern. A start movement pattern of a start data window may include, e.g., a start movement direction, a start movement level, a start movement speed, etc., of the start data window. A start movement pattern of a start data window may be estimated and recorded when the start data window is identified.

At 504, it may be determined whether a current movement direction of the current data window is consistent with the start movement direction of the start data window of the unfinished untrustworthy period. If the current movement direction is consistent with the start movement direction, it indicates that data values of both the current data window and the start data window are increasing or decreasing. At this time, the data value change of the current data window cannot compensate for the data value change of the start data window. If the current movement direction is inconsistent with the start movement direction, it indicates that data values of the current data window is increasing, and data values of the start data window is decreasing, or data values of the current data window is decreasing, and data values of the start data window is increasing. At this time, the data value change of the current data window may compensate for the data value change of the start data window. Whether the current movement direction is consistent with the start movement direction may be determined through, e.g., determining whether the sign of the current movement direction is the same as the sign of the start movement direction.

If it is determined at 504 that the current movement direction is consistent with the start movement direction, the process 500 may proceed to 528, where it is determined that the compensation status of the current data window does not meet the predetermined requirement. The compensation status of the current data window may be set to “false”.

If it is determined at 504 that the current movement direction is inconsistent with the start movement direction, the process 500 may proceed to 506, where it is determined whether there is at least one intermediate data window between the current data window and the start data window.

If it is determined at 506 that there is no intermediate data window between the current data window and the start data window, it may be determined whether the compensation status of the current data window meets a predetermined requirement based on a current movement level and/or a current movement speed of the current data window and a start movement level and/or a start movement speed of the start data window.

For example, a level difference between a current movement level of the current data window and a start movement level of the start data window and/or a speed difference between a current movement speed of the current data window and a start movement speed of the start data window may be calculated. It may be determined whether the compensation status of the current data window meets the predetermined requirement based on the calculated level difference and/or speed difference.

The process 500 may proceed to 508, where a level difference Level_{diff} between a current movement level Level_{current} of the current data window and a start movement level Levelₛₜₐᵣₜ of the start data window may be calculated, as shown by the following equation:

$${Level}_{diff} = \vert {Level}_{current} - {Level}_{start} \vert \qquad ( 4 )$$

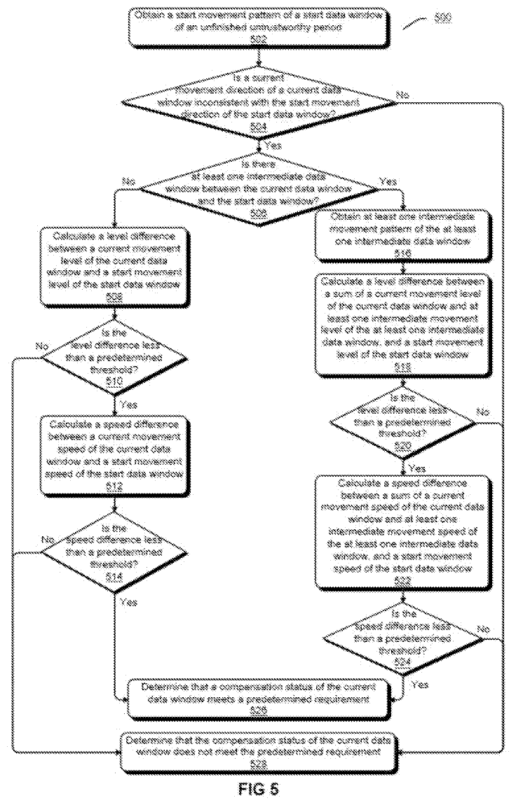

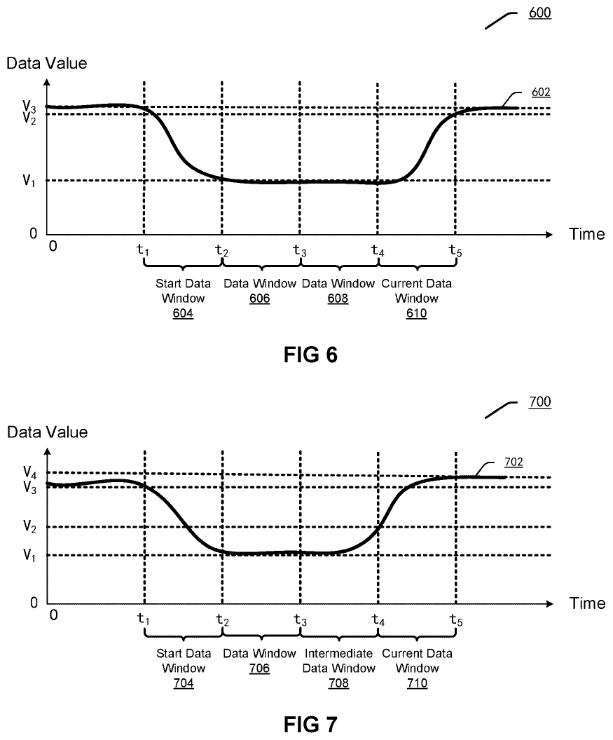

FIG. 6 illustrates a schematic diagram 600 of time-series data where there is no intermediate data window between a current data window and a start data window according to an embodiment of the present disclosure. Time-series data 602 may include a plurality of data windows. A start data window 604 has been identified from the time-series data 602, but an end data window corresponding to the start data window 604 has not been identified from the time-series data 602. There are a data window 606 and a data window 608 between a current data window 610 and the start data window 604. Data values of the data window 606 and the data window 608 are relatively stationary, thus there may be no anomalous data values detected when anomaly detection is performed on the data window 606 and the data window 608. Accordingly, the data window 606 and the data window 608 are not identified as intermediate data windows. In this case, the level difference between the current movement level of the current data window 610 and the start movement level of the start data window 604 may be calculated.

Referring back to FIG. 5, at 510, it may be determined whether the level difference calculated at 508 is less than a predetermined threshold. As an example, the predetermined threshold may be 80%.

If it is determined at 510 that the level difference is not less than the predetermined threshold, i.e., greater than or equal to the predetermined threshold, the process 500 may proceed to 528, where it is determined that a compensation status of the current data window does not meet the predetermined requirement. When the level difference is greater than or equal to the predetermined threshold, a gap between the movement level of the current data window and the movement level of the start data window is relatively large. In this case, there is a large gap between the change degree of data values of the current data window and the change degree of data values of the start data window. The data value change of the current data window may not compensate for the data value change of the start data window. Therefore, the compensation status of the current data window is determined not to meet the predetermined requirement.

If it is determined at 510 that the level difference is less than the predetermined threshold, the process 500 may proceed to 512, where a speed difference Speed_{diff} between a current movement speed Speed_{current} of the current data window and a start movement speed Speedₛₜₐᵣₜ of the start data window may be calculated, as shown by the following equation:

$${Speed}_{diff} = \vert {Speed}_{current} - {Speed}_{start} \vert \qquad ( 5 )$$

At 514, it may be determined whether the calculated speed difference is less than a predetermined threshold. As an example, the predetermined threshold may be 80%.

If it is determined at 514 that the speed difference is not less than the predetermined threshold, i.e., greater than or equal to the predetermined threshold, the process 500 may proceed to 528, where it is determined that a compensation status of the current data window does not meet the predetermined requirement. The compensation status of the current data window may be set to “false”. Since data values themselves of the time-series data may change at a certain speed, taking into account the speed difference between the current movement speed of the current data window and the start movement speed of the start data window may determine a compensation status of the current window more accurately.

If it is determined at 514 that the speed difference is less than the predetermined threshold, the process 500 may proceed to 526, where it is determined that a compensation status of the current data window meets the predetermined requirement. The compensation status of the current data window may be set to “true”.

Return to the step 506, if it is determined at 506 that there is at least one intermediate data window between the current data window and the start data window, it may be determined whether the compensation status of the current data window meets a predetermined requirement based on a current movement level and/or a current movement speed of the current data window, at least one intermediate movement level and/or intermediate movement speed of the at least one intermediate data window, and a start movement level and/or a start movement speed of the start data window. Herein, a movement pattern of an intermediate data window may be referred to as an intermediate movement pattern. For example, a level difference between a sum of a current movement level of the current data window and at least one intermediate movement level of at least one intermediate data window, and a start movement level of the start data window; and/or a speed difference between a sum of a current movement speed of the current data window and at least one intermediate movement speed of at least one intermediate data window, and a start movement speed of the start data window may be calculated. It may be determined whether the compensation status of the current data window meets the predetermined requirement based on the calculated level difference and/or speed difference.

The process 500 may proceed to 516, where at least one movement pattern of the at least one intermediate data window may be obtained. The at least one movement pattern of the at least one intermediate data window may include, e.g., at least one intermediate movement direction, at least one intermediate movement level, at least one intermediate movement speed, etc. of the at least one intermediate data window. The intermediate movement pattern of the intermediate data window may be estimated and recorded when the intermediate data window is identified. At 518, a level difference between a sum of a current movement level of the current data window and at least one intermediate movement level of the at least one intermediate data window, and a start movement level of the start data window may be calculated. When calculating the sum of the current movement level and the at least one intermediate movement level, it may be determined firstly whether a movement direction of the current data window is consistent with a movement direction of respective intermediate data window. For an intermediate data window whose movement direction is consistent with the movement direction of the current data window, the current movement level of the current data window and the intermediate movement level of the intermediate data window may be in an additive relationship; while for an intermediate data window whose movement direction is inconsistent with the movement direction of the current data window, the current movement level of the current data window and the intermediate movement level of the intermediate data window may be in a subtractive relationship. As an example, in the case where there is one intermediate data window between the current data window and the start data window, if the movement direction of the current data window is consistent with the movement direction of the intermediate data window, a sum of the current movement level Level_{current} and the intermediate movement level Levelᵢₙₜ may be obtained by adding the current movement level Level_{current} and the intermediate movement level Levelᵢₙₜ. In this case, a process for calculating a level difference Level_{diff} may be represented, e.g., by the following equation:

$${Level}_{diff} = \vert ( {Level}_{current} + {Level}_{int} ) - {Level}_{start} \vert \qquad ( 6 )$$

FIG. 7 illustrates a schematic diagram 700 of time-series data where there is one intermediate data window between a current data window and a start data window according to an embodiment of the present disclosure. Time-series data 702 may include a plurality of data windows. A start data window 704 has been identified from the time-series data 702, but an end data window corresponding to the start data window 704 has not been identified from the time-series data 702. There are a data window 706 and a data window 708 between the current data window 710 and the start data window 704. Data values of the data window 706 are relatively stationary, thus there may be no anomalous data values detected when anomaly detection is performed on the data window 706. Accordingly, the data window 706 is not identified as an intermediate data window. There are fluctuations in data values of the data window 708, thus anomalous data values may be detected when anomaly detection is performed on the data window 708. Accordingly, the data window 708 is identified as an intermediate data window. In this case, a level difference between a sum of a current movement level of the current data window 710 and an intermediate movement level of the intermediate data window 708, and a start movement level of the start data window 704 may be calculated. Since the movement direction of the current data window 710 is consistent with the movement direction of the intermediate data window 708, when calculating the level difference, the current movement level of the current data window 710 and the intermediate movement level of the intermediate data window 708 may be in an additive relationship, as shown in the above equation (6). If the movement direction of the current data window is inconsistent with the movement direction of the intermediate data window, a sum of the current movement level Level_{current} and the intermediate movement level Levelᵢₙₜ may be obtained through subtracting the intermediate movement level Levelᵢₙₜ from the current movement level Level_{current}. In this case, a process for calculating a level difference Level_{diff} may be represented, e.g., by the following equation:

$${Level}_{diff} = \vert ( {Level}_{current} - {Level}_{int} ) - {Level}_{start} \vert \qquad ( 7 )$$

Referring back to FIG. 5, at 520, it may be determined whether the calculated level difference is less than a predetermined threshold. As an example, the predetermined threshold may be 80%.

If it is determined at 520 that the level difference is not less than the predetermined threshold, i.e., greater than or equal to the predetermined threshold, the process 500 may proceed to 528, where it is determined that a compensation status of the current data window does not meet the predetermined requirement.

If it is determined at 514 that the level difference is less than the predetermined threshold, the process 500 may proceed to 522, where a speed difference between a sum of a current movement speed of the current data window and at least one intermediate movement speed of the at least one intermediate data window, and a start movement speed of the start data window is calculated. When calculating the sum of the current movement speed and the at least one intermediate movement speed, it may be determined firstly whether a movement direction of the current data window is consistent with a movement direction of respective intermediate data window. For an intermediate data window whose movement direction is consistent with the movement direction of the current data window, the current movement speed of the current data window and the intermediate movement speed of the intermediate data window may be in an additive relationship; while for an intermediate data window whose movement direction is inconsistent with the movement direction of the current data window, the current movement speed of the current data window and the intermediate movement speed of the intermediate data window may be in a subtractive relationship. As an example, in the case where there is one intermediate data window between the current data window and the start data window, if the movement direction of the current data window is consistent with the movement direction of the intermediate data window, a sum of the current movement speed Speed_{current} and the intermediate movement speed Speedᵢₙₜ may be obtained through adding the current movement speed Speed_{current} and the intermediate movement speed Levelᵢₙₜ. In this case, a process for calculating a speed difference Speed_{diff} may be represented, e.g., by the following equation:

$${Speed}_{diff} = \vert ( {Speed}_{current} + {Speed}_{int} ) - {Speed}_{start} \vert \qquad ( 8 )$$

Taking the time-series data 702 in FIG. 7 as an example, since the movement direction of the current data window 710 is consistent with the movement direction of the intermediate data window 708, when calculating the speed difference, the current movement speed of the current data window 710 and the intermediate movement speed of the intermediate data window 708 may be in an additive relationship, as shown in the above equation (8).

If the movement direction of the current data window is inconsistent with the movement direction of the intermediate data window, a sum of the current movement speed Speed_{current} and the intermediate movement speed Speedᵢₙₜ may be obtained through subtracting the intermediate movement speed Speedᵢₙₜ from the current movement speed Speed_{current}. In this case, a process for calculating the speed difference Speed_{diff} may be represented, e.g., by the following equation:

$${Speed}_{diff} = \vert ( {Speed}_{current} - {Speed}_{int} ) - {Speed}_{start} \vert \qquad ( 9 )$$

At 524, it may be determined whether the calculated speed difference is less than a predetermined threshold. As an example, the predetermined threshold may be 80%.

If it is determined at 524 that the speed difference is not less than the predetermined threshold, i.e., greater than or equal to the predetermined threshold, the process 500 may proceed to 528, where it is determined that the compensation status of the current data window does not meet the predetermined requirement.

If it is determined at 524 that the speed difference is less than the predetermined threshold, the process 500 may proceed to 526, where it is determined that the compensation status of the current data window meets the predetermined requirement. The compensation status of the current data window may be set to “true”.

Through the process 500, the current data window may be comprehensively evaluated, to accurately determine whether the data value change of the current data window indeed compensates for the data value change of a previous data window, thereby the time window in which time-series data for the target metric returns to normal values may be reliably identified.

It should be appreciated that the process for calculating the level difference and the speed difference is described above by taking as an example that there is one intermediate data window between a current data window and a start data window, but the embodiments of the present disclosure are not limited thereto. In the case where there are a plurality of intermediate data windows between a current data window and a start data window, the level difference and the speed difference may be calculated in a similar manner.

It should be appreciated that the process for determining the compensation status of the current data window described above in conjunction with FIG. 5 to FIG. 7 is merely exemplary. According to actual application requirements, the steps in the process for determining the compensation status of the current data window may be replaced or modified in any manner, and the process may include more or fewer steps. For example, in the process 500, where it is determined that the current movement direction of the current data window is inconsistent with the start movement direction of the start data window, the compensation status of the current data window is determined based on both the level difference and the speed difference. However, in some instances, it is also possible to determine the compensation status of the current data window based on either one of the level difference and the speed difference. In addition, the specific order or hierarchy of the steps in the process 500 is only exemplary, and the process for determining the compensation status of the current data window may be performed in an order different from the described one.

The process for detecting the untrustworthy period of the metric according to the embodiments of the present disclosure is described above in conjunction with FIGS. 1 to 7. Identification of the start data window and the end data window of the untrustworthy period is performed on data of time-series data. The data of time-series data is easy to obtain and process. For example, for the start data window, the start data window may be identified based on whether the current data window contains an abnormal data value and whether there is an unfinished untrustworthy period. For the end data window, the end data window may be identified through determining the compensation status of the current data window by a movement pattern such as the movement direction, the movement level, the movement speed, etc. Whether the current data window contains an abnormal data value may be determined through existing anomaly detection techniques. The movement direction, the movement level, and the movement speed of each time window may be calculated from a start time, an end time, a start data value and an end data value, etc. of the time window. Identification of the start data window and the end data window according to the embodiments of the present disclosure focuses on processing the data of the time-series data, and avoids the need to analyze a root cause of an abnormal data value. The analysis on the root cause is a complex and challenging task, especially for an aggregated metric or a derived metric that is aggregated layer by layer.

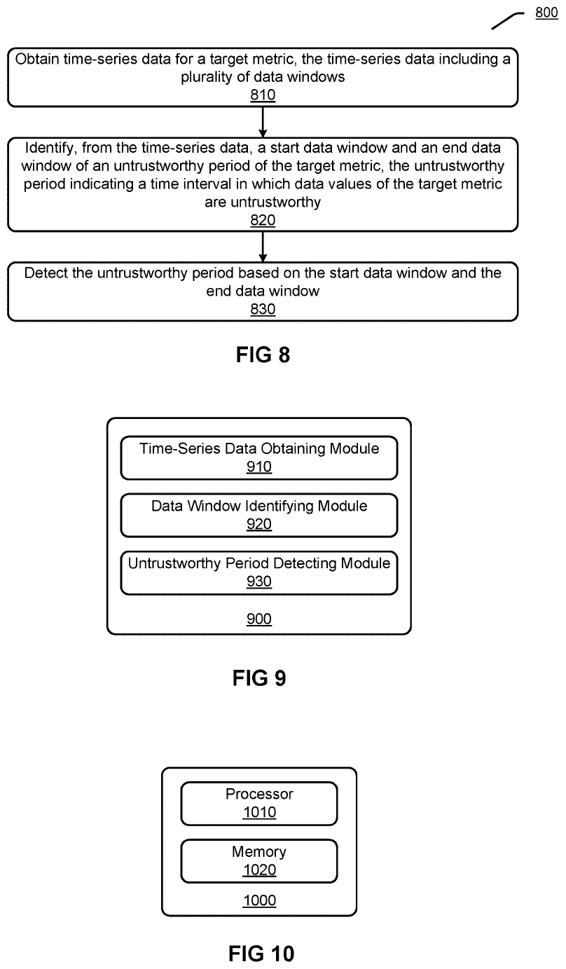

FIG. 8 is a flowchart of an exemplary method 800 for detecting an untrustworthy period of a metric according to an embodiment of the present disclosure.

At 810, time-series data for a target metric may be obtained, the time-series data including a plurality of data windows.

At 820, a start data window and an end data window of an untrustworthy period of the target metric may be identified from the time-series data, the untrustworthy period indicating a time interval in which data values of the target metric are untrustworthy.

At 830, the untrustworthy period may be detected based on the start data window and the end data window.

In an implementation, the identifying a start data window and an end data window may include: receiving a current data window; determining whether the current data window contains an abnormal data value; and in response to determining that the current data window contains an abnormal data value, identifying the current data window as one of the start data window, the end data window, and an intermediate data window.

The method 800 may further comprise: in response to determining that the current data window contains an abnormal data value, estimating a current movement pattern of the current data window.

The current data window may have a start time, an end time, a start data value, and an end data value. The current movement pattern may include at least one of a current movement direction, a current movement level, and a current movement speed. The estimating a current movement pattern may include performing at least one of: determining the current movement direction based on the start data value and the end data value; calculating the current movement level based on the start data value and the end data value; and calculating the current movement speed based on the start data value, the end data value, the start time, and the end time.

The identifying the current data window as one of the start data window, the end data window, and an intermediate data window may comprise: determining whether there is an unfinished untrustworthy period; and in response to determining that there is no unfinished untrustworthy period, identifying the current data window as the start data window.

The method 800 may further comprise: in response to determining that there is no unfinished untrustworthy period, creating a new untrustworthy period.

The method 800 may further comprise: in response to determining that there is an unfinished untrustworthy period, determining whether a compensation status of the current data window meets a predetermined requirement; and in response to determining that the compensation status meets the predetermined requirement, identifying the current data window as the end data window.

The method 800 may further comprise: in response to determining that the compensation status meets the predetermined requirement, finishing the unfinished untrustworthy period. The method 800 may further comprise: in response to determining that the compensation status does not meet the predetermined requirement, identifying the current data window as the intermediate data window.

The determining whether the compensation status meets a predetermined requirement may include: determining whether the compensation status meets the predetermined requirement based at least on a current movement pattern of the current data window and a start movement pattern of a start data window of the unfinished untrustworthy period.

The determining whether a compensation status meets a predetermined requirement may comprise: determining whether a current movement direction of the current data window is consistent with a start movement direction of the start data window of the unfinished untrustworthy period; and in response to determining that the current movement direction is consistent with the start movement direction, determining that the compensation status does not meet the predetermined requirement.

The method 800 may further comprise: in response to determining that the current movement direction is inconsistent with the start movement direction, determining whether there is at least one intermediate data window between the current data window and the start data window; in response to determining that there is no intermediate data window between the current data window and the start data window, calculating a level difference between a current movement level of the current data window and a start movement level of the start data window; and determining whether the compensation status meets the predetermined requirement based on the level difference.

The method 800 may further comprise: in response to determining that the current movement direction is inconsistent with the start movement direction, determining whether there is at least one intermediate data window between the current data window and the start data window; in response to determining that there is no intermediate data window between the current data window and the start data window, calculating a speed difference between a current movement speed of the current data window and a start movement speed of the start data window; and determining whether the compensation status meets the predetermined requirement based on the speed difference.

The method 800 may further comprise: in response to determining that there is at least one intermediate data window between the current data window and the start data window, calculating a level difference between a sum of a current movement level of the current data window and at least one intermediate movement level of the at least one intermediate data window, and a start movement level of the start data window; and determining whether the compensation status meets the predetermined requirement based on the level difference.

The method 800 may further comprise: in response to determining that there is at least one intermediate data window between the current data window and the start data window, calculating a speed difference between a sum of a current movement speed of the current data window and at least one intermediate movement speed of the at least one intermediate data window, and a start movement speed of the start data window; and determining whether the compensation status meets the predetermined requirement based on the speed difference.

In an implementation, the detecting the untrustworthy period based on the start data window and the end data window may include: determining a time-series data segment in the time-series data including the start data window and the end data window; and detecting the time-series data segment as the untrustworthy period.

It should be appreciated that the method 800 may further comprise any step/process for detecting the untrustworthy period of the metric according to the embodiments of the present disclosure as mentioned above.

FIG. 9 illustrates an exemplary apparatus 900 for detecting an untrustworthy period of a metric according to an embodiment of the present disclosure.

The apparatus 900 may include: a time-series data obtaining module 910, for obtaining time-series data for a target metric, the time-series data including a plurality of data windows; a data window identifying module 920, for identifying, from the time-series data, a start data window and an end data window of an untrustworthy period of the target metric, the untrustworthy period indicating a time interval in which data values of the target metric are untrustworthy; and an untrustworthy period detecting module 930, for detecting the untrustworthy period based on the start data window and the end data window. Moreover, the apparatus 900 may further comprise any other modules configured for detecting the untrustworthy period of the metric according to the embodiments of the present disclosure as mentioned above.

FIG. 10 illustrates an exemplary apparatus 1000 for detecting an untrustworthy period of a metric according to an embodiment of the present disclosure.

The apparatus 1000 may include at least one processor 1010 and a memory 1020 storing computer-executable instructions. The computer-executable instructions, when executed, may cause the at least one processor 1010 to: obtain time-series data for a target metric, the time-series data including a plurality of data windows; identify, from the time-series data, a start data window and an end data window of an untrustworthy period of the target metric, the untrustworthy period indicating a time interval in which data values of the target metric are untrustworthy; and detect the untrustworthy period based on the start data window and the end data window.

In an implementation, the identifying a start data window and an end data window may comprise: receiving a current data window; determining whether the current data window contains an abnormal data value; and in response to determining that the current data window contains an abnormal data value, identifying the current data window as one of the start data window, the end data window, and an intermediate data window.

The identifying the current data window as one of the start data window, the end data window, and an intermediate data window may comprise: determining whether there is an unfinished untrustworthy period; and in response to determining that there is no unfinished untrustworthy period, identifying the current data window as the start data window.

It should be appreciated that the processor 1010 may further perform any other step/process of the method for detecting the untrustworthy period of the metric according to the embodiments of the present disclosure as mentioned above.

The embodiments of the present disclosure propose a computer program product for detecting an untrustworthy period of a metric, comprising a computer program that is executed by at least one processor for: obtaining time-series data for a target metric, the time-series data including a plurality of data windows; identifying, from the time-series data, a start data window and an end data window of an untrustworthy period of the target metric, the untrustworthy period indicating a time interval in which data values of the target metric are untrustworthy; and detecting the untrustworthy period based on the start data window and the end data window. In addition, the computer program may further be performed for implementing any other steps/processes of a method for detecting an untrustworthy period of a metric according to embodiments of the present disclosure described above.

The embodiments of the present disclosure may be embodied in a non-transitory computer-readable medium. The non-transitory computer readable medium may comprise instructions that, when executed, cause one or more processors to perform any operation of a method for detecting an untrustworthy period of a metric according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform. Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for detecting an untrustworthy period of a metric, comprising:
obtaining time-series data for a target metric, the time-series data including a plurality of data windows;
identifying, from the time-series data, a start data window and an end data window of an untrustworthy period of the target metric, the untrustworthy period indicating a time interval in which data values of the target metric are untrustworthy; and
detecting the untrustworthy period based on the start data window and the end data window.

2. The method of claim 1, wherein the identifying a start data window and an end data window comprises:
receiving a current data window;
determining whether the current data window contains an abnormal data value; and
in response to determining that the current data window contains an abnormal data value, identifying the current data window as one of the start data window, the end data window, and an intermediate data window.

3. The method of claim 2, further comprising:
in response to determining that the current data window contains an abnormal data value, estimating a current movement pattern of the current data window.

4. The method of claim 3, wherein the current data window has a start time, an end time, a start data value, and an end data value, the current movement pattern includes at least one of a current movement direction, a current movement level, and a current movement speeds, and the estimating a current movement pattern comprises performing at least one of:
determining the current movement direction based on the start data value and the end data value;
calculating the current movement level based on the start data value and the end data value; and
calculating the current movement speed based on the start data value, the end data value, the start time, and the end time.

5. The method of claim 2, wherein the identifying the current data window as one of the start data window, the end data window, and an intermediate data window comprises:
determining whether there is an unfinished untrustworthy period; and
in response to determining that there is no unfinished untrustworthy period, identifying the current data window as the start data window.

6. The method of claim 5, further comprising:
in response to determining that there is an unfinished untrustworthy period, determining whether a compensation status of the current data window meets a predetermined requirement; and
in response to determining that the compensation status meets the predetermined requirement, identifying the current data window as the end data window.

7. The method of claim 6, further comprising:
in response to determining that the compensation status does not meet the predetermined requirement, identifying the current data window as the intermediate data window.

8. The method of claim 6, wherein the determining whether the compensation status meets a predetermined requirement comprises:
determining whether the compensation status meets the predetermined requirement based at least on a current movement pattern of the current data window and a start movement pattern of a start data window of the unfinished untrustworthy period.

9. The method of claim 6, wherein the determining whether a compensation status meets a predetermined requirement comprises:
determining whether a current movement direction of the current data window is consistent with a start movement direction of the start data window of the unfinished untrustworthy period; and
in response to determining that the current movement direction is consistent with the start movement direction, determining that the compensation status does not meet the predetermined requirement.

10. The method of claim 9, further comprising:
in response to determining that the current movement direction is inconsistent with the start movement direction, determining whether there is at least one intermediate data window between the current data window and the start data window;
in response to determining that there is no intermediate data window between the current data window and the start data window, calculating a level difference between a current movement level of the current data window and a start movement level of the start data window; and
determining whether the compensation status meets the predetermined requirement based on the level difference.

11. The method of claim 9, further comprising:
in response to determining that the current movement direction is inconsistent with the start movement direction, determining whether there is at least one intermediate data window between the current data window and the start data window;
in response to determining that there is no intermediate data window between the current data window and the start data window, calculating a speed difference between a current movement speed of the current data window and a start movement speed of the start data window; and
determining whether the compensation status meets the predetermined requirement based on the speed difference.

12. The method of claim 10, further comprising:
in response to determining that there is at least one intermediate data window between the current data window and the start data window, calculating a level difference between a sum of a current movement level of the current data window and at least one intermediate movement level of the at least one intermediate data window, and a start movement level of the start data window; and
determining whether the compensation status meets the predetermined requirement based on the level difference.

13. The method of claim 10, further comprising:
in response to determining that there is at least one intermediate data window between the current data window and the start data window, calculating a speed difference between a sum of a current movement speed of the current data window and at least one intermediate movement speed of the at least one intermediate data window, and a start movement speed of the start data window; and
determining whether the compensation status meets the predetermined requirement based on the speed difference.

14. An apparatus for detecting an untrustworthy period of a metric, comprising:
at least one processor; and
a memory storing computer-executable instructions that, when executed, cause the at least one processor to:
obtain time-series data for a target metric, the time-series data including a plurality of data windows,
identify, from the time-series data, a start data window and an end data window of an untrustworthy period of the target metric, the untrustworthy period indicating a time interval in which data values of the target metric are untrustworthy, and
detect the untrustworthy period based on the start data window and the end data window.

15. A computer program product for detecting an untrustworthy period of a metric, comprising a computer program that is executed by at least one processor for:
obtaining time-series data for a target metric, the time-series data including a plurality of data windows;
identifying, from the time-series data, a start data window and an end data window of an untrustworthy period of the target metric, the untrustworthy period indicating a time interval in which data values of the target metric are untrustworthy; and
detecting the untrustworthy period based on the start data window and the end data window.
